(19) United States
(12) Patent Application Publication
(10) Pub. No.: US 2003/0175566 A1
(43) Pub. Date: Sep. 18, 2003

(54) Fuel cell power systems and methods of operating fuel cell power systems

(76) Inventors: John M. Fisher, Spokane, WA (US); Heather Lynn-Beese Cummins, Spokane, WA (US); Jeremy C. McClintock, Spokane, WA (US)

Correspondence Address: WELLS ST. JOHN P.S., 601 W. FIRST AVENUE, SUITE 1300, SPOKANE, WA, 99201, US

(21) Appl. No.: 10/099,103

(22) Filed: Mar. 12, 2002

(51) Int. Cl. H01M 8/04

(52) U.S. Cl. 429/22; 429/13; 429/24; 429/23

(57) ABSTRACT

A fuel cell power system comprises a housing; a fuel cell supported by the housing, configured to convert chemical energy into electrical energy to be selectively supplied to a load; a current sensor configured to determine current flow from the fuel cell to a load; and a controller coupled to the current sensor to monitor current flow from the fuel cell to the load and to control one or more operational parameters of the fuel cell power system in response to the current flow. A temperature sensor is also provided, in embodiment, to sense the temperature of the fuel cell. The controller is coupled to the temperature sensor to monitor temperature of the fuel cell and to control one or more operational parameters of the fuel cell power system in response to the current flow.

### TECHNICAL FIELD

The invention relates to fuel cell power systems and methods of operating fuel cell power systems.

### BACKGROUND OF THE INVENTION

Fuel cells are known in the art. The fuel cell is an electrochemical device which reacts hydrogen, and oxygen, which is usually supplied from the ambient air, to produce electricity and water. The basic process is highly efficient and fuel cells fueled directly by hydrogen are substantially pollution free. Further, since fuel cells can be assembled into stacks of various sizes, power systems have been developed to produce a wide range of electrical power output levels and thus can be employed in numerous applications. The teachings of the following patents, U.S. Pat. Nos. 4,590,135; 4,599,282; 4,689,280; 5,242,764; 5,858,569; 5,981,098; 6,013,386; 6,017,648; 6,030,718; 6,040,072; 6,040,076; 6,096,449; 6,132,895; 6,171,720; 6,207,308; 6,218,039; and 6,261,710 are incorporated by reference herein.

A fuel cell produces an electromotive force by reacting fuel and oxygen at respective electrode interfaces which share a common electrolyte.

In a fuel cell, fuel such as hydrogen gas is introduced at a first electrode (anode) where it reacts electrochemically in the presence of a catalyst to produce electrons and protons. The electrons are circulated from the first electrode to a second electrode (cathode) through an electrical circuit which couples these respective electrodes. Further, the protons pass through an electrolyte to the second electrode (cathode). Simultaneously, an oxidant, such as oxygen gas, (or air), is introduced to the second electrode where the oxidant reacts electrochemically in the presence of the catalyst and is combined with the electrons from the electrical circuit and the protons (having come across the electrolyte) thus forming water. This reaction further completes the electrical circuit.

The following half cell reactions take place:

(1) H₂→2H⁺+2e−

(2) (½)O₂+2H⁺+2e−→H₂O

As noted above the fuel-side electrode is the anode, and the oxygen-side electrode is the cathode. The external electric circuit conveys the generated electrical current and can thus extract electrical power from the cell. The overall fuel cell reaction produces electrical energy which is the sum of the separate half cell reactions occurring in the fuel cell less its internal losses.

While PEM fuel cells of various designs have operated with varying degrees of success, they have also had shortcomings which have detracted from their usefulness. For example, PEM fuel cell power systems typically have a number of individual fuel cells which are serially electrically connected (stacked) together so that the power system can have a increased output voltage. In this arrangement, if one of the fuel cells in the stack fails, it no longer contributes voltage and power. One of the more common failures of such PEM fuel cell power systems is where a membrane electrode assembly (MEA) becomes less hydrated than other MEAs in the same fuel cell stack. This loss of membrane hydration increases the electrical resistance of the effected fuel cell, and thus results in more waste heat being generated. In turn, this additional heat drys out the membrane electrode assembly. This situation creates a negative hydration spiral. The continual overheating of the fuel cell can eventually cause the polarity of the effected fuel cell to reverse such that it now begins to dissipate electrical power from the rest of the fuel cells in the stack. If this condition is not rectified, excessive heat generated by the failing fuel cell will cause the membrane electrode assembly to perforate and thereby leak hydrogen. When this perforation occurs the fuel cell stack must be completely disassembled and repaired. Depending upon the design of fuel cell stack being employed, this repair or replacement may be a costly, and time consuming endeavor.

Some of these problems are solved by fuel cell systems including removable modules as described in commonly assigned patents. For example, commonly assigned U.S. Pat. No. 6,218,035 to Fuglevand et al., incorporated herein by reference, discloses a proton exchange membrane fuel cell power system including a plurality of discrete fuel cell modules having multiple membrane electrode diffusion assemblies. Each of the membrane electrode diffusion assemblies have opposite anode and cathode sides. Current collectors are individually disposed in juxtaposed ohmic electrical contact with opposite anode and cathode sides of each of the membrane electrode diffusion assemblies. Individual force application assemblies apply a given force to the current collectors and the individual membrane electrode diffusion assemblies. The proton exchange membrane fuel cell power system also includes an enclosure mounting a plurality of subracks which receive the discrete fuel cell modules. In such a modular design, if one fuel module fails, it can be removed and replaced without the difficulty of disassembling a stack.

Attention is directed to U.S. Pat. No. 6,096,449 to Fuglevand et al., which is incorporated by reference herein. This patent discloses a shunt controller which is electrically coupled with a fuel cell and which, at times, shunts electrical current between the anode and cathode of the fuel cell. The controller comprises voltage and current sensors which are disposed in voltage and current sensing relation relative to the electrical power output of the fuel cell. The controller, under certain circumstances or at times (e.g., if voltage or current output of the fuel cell is below a predetermined minimum), closes an electrical switch to shunt current between the anode and the cathode of the fuel cell. Substantially simultaneously, the controller causes a valve to terminate the supply of fuel gas to the fuel cell. Alternatively, the shunt controller periodically shorts current between the anode and cathode of the fuel cell, while simultaneously allowing substantially continuous delivery of fuel gas to the fuel cell. The periodic shorting increases the overall electrical power output of the fuel cell. It is speculated that this repeated, and periodic shorting causes each of the fuel cells to be “conditioned”, that is, such shorting is believed to cause an increase in the amount of water that is made available to the MEA of the fuel cell thereby increasing the MEAs performance. It is also conceivable that the shorting provides a short term increase in heat dissipation that is sufficient to evaporate excess water from the diffuser layers which are mounted on the MEA. This evaporation of water thus makes more oxygen from the ambient air available to the cathode side of the MEA. Whatever the cause, the shorting appears to increase the proton conductivity of the MEA. This increase in proton conductivity results in a momentary increase in the power output of the fuel cell which diminishes slowly over time. The overall increase in the electrical power output of the fuel cell, as controlled by the adjustably sequential and periodic shorting of individual, and groups of fuel cells, results in the entire serially connected group of fuel cells to increase in its overall power production.

It is desirable to optimize performance of a fuel cell power system. If one module of a fuel cell power system has operating parameters that are different from other modules, it may be possible to optimize the system by controlling the operating parameters based on parameters of one of the modules or adjusting parameters of other modules, for example.

### BRIEF DESCRIPTION OF THE DRAWINGS

Preferred embodiments of the invention are described below with reference to the following accompanying drawings.

FIG. 1 is a perspective view of an exemplary fuel cell power system, partly in block diagram form.

FIG. 2 is a block diagram of components of the fuel cell power system.

FIG. 3 is a sectional view of the housing of the fuel cell power system of FIG. 1 taken along line 3-3 of FIG. 1.

FIG. 4 is a block diagram of an exemplary fuel cell cartridge.

FIG. 5 is a circuit diagram showing circuitry including shunt control circuitry in accordance with one embodiment.

FIG. 6 is a circuit diagram showing details of the shunt control circuitry of FIG. 5, in accordance with one embodiment.

FIG. 7 is a circuit diagram showing details of the shunt control circuitry of FIG. 5, in accordance with an alternative embodiment.

FIG. 8 is a flow chart of logic employed in the circuitry of FIGS. 2 and 5.

FIG. 9 is a flow chart of logic employed in the circuitry of FIGS. 2 and 5 in an alternative embodiment, or in addition to the logic of FIG. 8.

FIG. 10 is a flow chart of logic employed in the circuitry of FIGS. 2 and 5 in an alternative embodiment, or in addition to the logic of FIGS. 8 and/or 9.

FIG. 11 is a map illustrating how FIGS. 12A-E are to be assembled.

FIGS. 12A-E when assembled provide a flow chart of logic employed in the circuitry of FIGS. 2 and 5 in an alternative embodiment, or in addition to the logic of FIGS. 8 and/or 9 and/or 10.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

One aspect of the invention relates to improving performance of a modular fuel cell power system by equalizing the operating temperature of each module or cartridge using module temperature and current as inputs and shunting duty cycle as an output.

One aspect of the invention provides a fuel cell power system comprising a housing; a fuel cell supported by the housing, configured to convert chemical energy into electrical energy to be selectively supplied to a load; an air passage in the housing configured to move air relative to the fuel cell; means for adjusting mass/energy flow through the air passage; a sensor configured to sense a parameter of the fuel cell; and a controller coupled to the current sensor to monitor current flow from the fuel cell to the load and to control mass/energy flow adjusting means in response to the sensed parameter.

Another aspect of the invention provides a fuel cell power system comprises a housing; a fuel cell supported by the housing, configured to convert chemical energy into electrical energy to be selectively supplied to a load; a current sensor configured to determine current flow from the fuel cell to a load; and a controller coupled to the current sensor to monitor current flow from the fuel cell to the load and to control one or more operational parameters of the fuel cell power system in response to the current flow.

Another aspect of the invention relates to a fuel cell power system comprising a housing; a fuel cell supported by the housing, configured to convert chemical energy into electrical energy to be selectively supplied to a load; a fan supported by the housing and configured to move air relative to the fuel cell; a current sensor configured to determine current flow from the fuel cell to a load; and a controller coupled to the current sensor to monitor current flow from the fuel cell to the load and to control the fan in response to the current flow.

Another aspect of the invention relates to a fuel cell power system comprises a housing having an interior and exterior, and an opening extending between the interior and exterior; a fuel cell supported in the housing, configured to convert chemical energy into electrical energy to be selectively supplied to a load; an air passage in fluid communication with the opening in the housing and configured to pass air relative to the fuel cell; a vane supported by the housing in the air passage and moveable between an open position and a closed position; a current sensor configured to determine current flow from the fuel cell to a load; and a controller coupled to the current sensor to monitor current flow from the fuel cell to the load and to control the position of the vane in response to the current flow.

Another aspect of the invention relates to a fuel cell power system comprising a fuel cell having a cathode and an anode adapted to be coupled to a fuel supply, and configured to produce electrical power having a current and voltage output; a temperature sensor in temperature sensing relation to the fuel cell; and a controller electrically coupled with the fuel cell and the temperature sensor, and configured to shunt current between the anode and cathode of the fuel cell according to a duty cycle, the controller further being configured to selectively adjust the duty cycle in response to the sensed temperature.

Another aspect of the invention relates to a fuel cell power system comprising a fuel cell having a cathode and an anode adapted to be coupled to a fuel supply, and configured to produce electrical power having a current and voltage output; a current sensor configured to sense current produced by the fuel cell; and a controller electrically coupled with the fuel cell and the current sensor, and configured to shunt current between the anode and cathode of the fuel cell according to a duty cycle, the controller further being configured to selectively adjust the duty cycle in response to the sensed current.

Another aspect of the invention relates to a fuel cell power method comprising providing a housing; supporting a fuel cell from the housing, and converting chemical energy into electrical energy to be selectively supplied to a load; providing an air passage in the housing to move air relative to the fuel cell; adjusting mass/energy flow through the air passage; determining a parameter of the fuel cell; and controlling mass/energy flow in response to the parameter.

Another aspect of the invention relates to a fuel cell power method comprising providing a housing; supporting a fuel cell by the housing, and converting chemical energy into electrical energy to be selectively supplied to a load, using the fuel cell; moving air relative to the fuel cell using a fan supported by the housing; determining current flow from the fuel cell to a load, using a current sensor; and monitoring current flow from the fuel cell to the load and controlling the fan in response to the current flow.

Another aspect of the invention relates to a fuel cell power method comprising providing a housing having an interior and exterior, and an opening extending between the interior and exterior; supporting a fuel cell supported in the housing, and converting chemical energy into electrical energy to be selectively supplied to a load, using the fuel cell; providing an air passage in fluid communication with the opening in the housing and configured to pass air relative to the fuel cell; supporting a vane in the air passage, moveable between an open position and a closed position; determining current flow from the fuel cell to a load using a current sensor; and monitoring current flow from the fuel cell to the load, and controlling the position of the vane in response to the current flow.

Another aspect of the invention relates to a fuel cell method comprising providing a fuel cell having a cathode and an anode adapted to be coupled to a fuel supply, and configured to produce electrical power having a current and voltage output; providing a temperature sensor in temperature sensing relation to the fuel cell; and shunting current between the anode and cathode of the fuel cell according to a duty cycle, and selectively adjusting the duty cycle in response to the sensed temperature.

Yet another aspect of the invention relates to a fuel cell power method comprising providing a fuel cell having a cathode and an anode adapted to be coupled to a fuel supply, and configured to produce electrical power having a current and voltage output; providing a current sensor configured to sense current produced by the fuel cell; and shunting current between the anode and cathode of the fuel cell according to a duty cycle, and selectively adjusting the duty cycle in response to the sensed current.

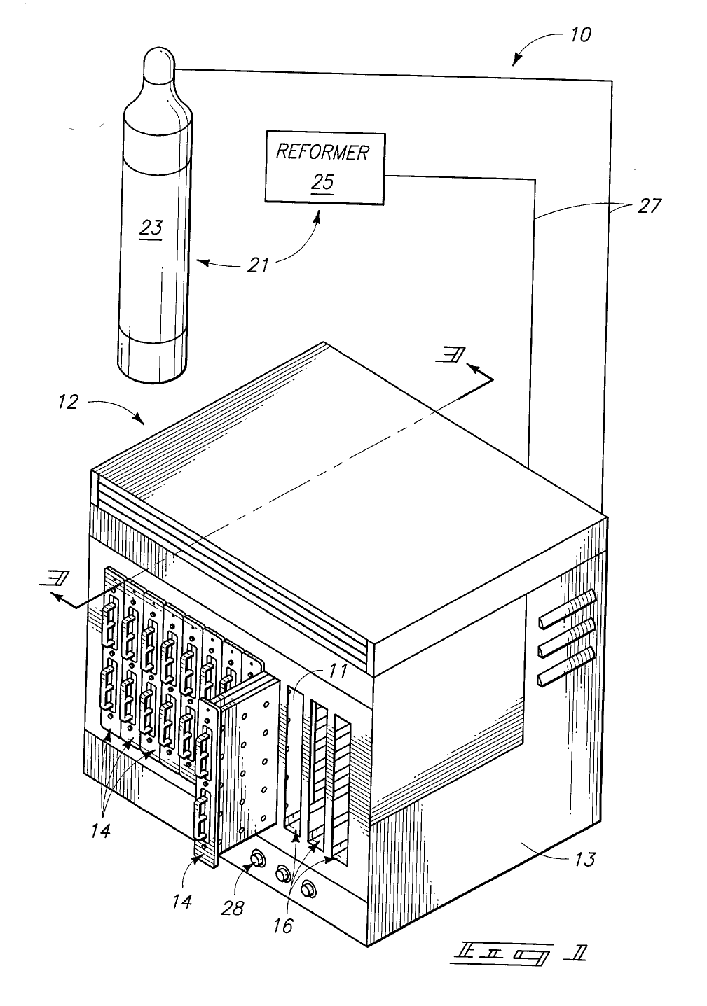

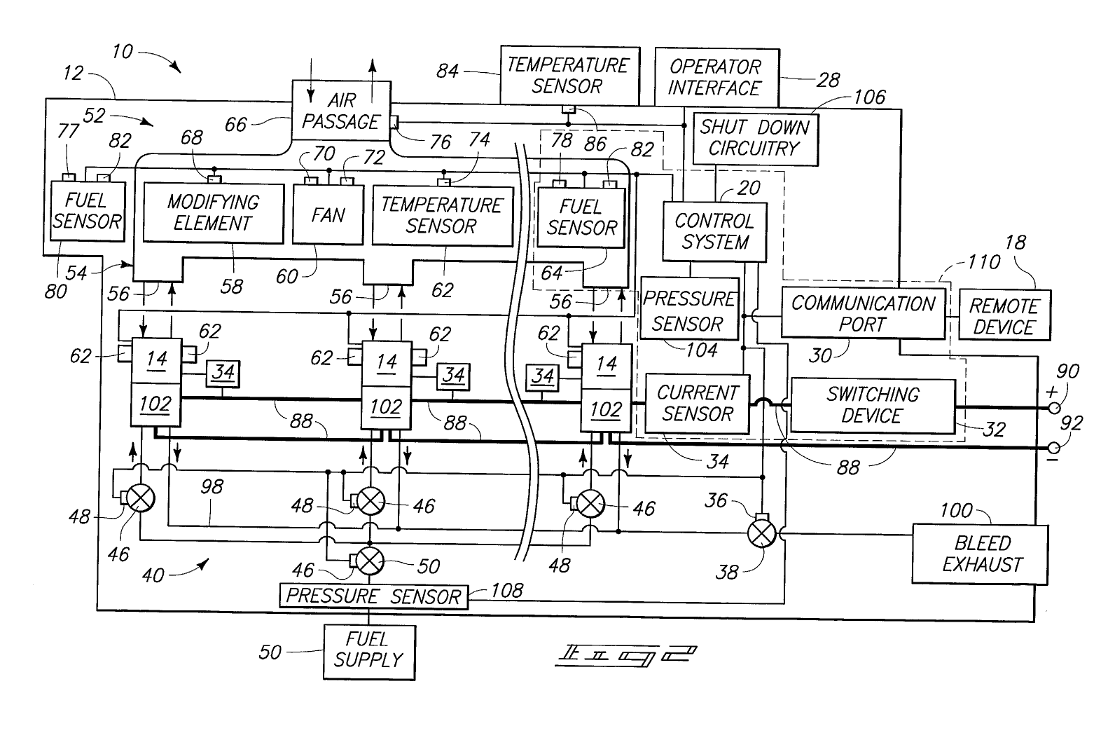

Referring to FIG. 1, one configuration of an ion exchange membrane fuel cell power system 10 is illustrated. The depicted configuration of fuel cell power system 10 is exemplary and other configurations are possible. As shown, fuel cell power system 10 includes a housing 12 including a principal enclosure 13. The principal enclosure 13 includes a subrack 11 releasably supporting a plurality of hand manipulable fuel cell cartridges or ion exchange membrane fuel cell modules 14. The principal enclosure 13 is defined by a top surface; bottom surface; front sidewall; rear sidewall; left sidewall; and right sidewall. In this arrangement, the principal enclosure will receive a plurality of modules 14, each enclosing a membrane electrode diffusion assembly (not shown).

More particularly, a plurality of individual module apertures 16 are formed in the subrack 11, and are operable to individually receive the respective fuel cell modules 14, and position them in predetermined spaced relation, one to the other. The individual ion exchange membrane fuel cell modules 14 are coupled in fluid flowing relation to a source of a substantially pure or dilute fuel generally indicated by the numeral 21. The fuel supply may comprise a source of bottled and compressed fuel gas generally indicated by the numeral 23; or a fuel gas stream which is provided by way of a chemical reactor or reformer 25 which produces the fuel stream for use by individual ion exchange fuel cell modules 14. A conduit 27 couples either the fuel gas supply 23 or 25 with the respective ion exchange fuel cell modules 14. When a chemical reformer 25 is provided, the reformer would receive a suitable hydrocarbon stream such as natural gas; propane; butane; and other fuels and would thereafter, through a chemical reaction, release a fuel gas stream which would then be delivered by way of the conduit 27. The fuel cell power system 10 may also include a fuel gas recovery and recycling system (not shown) which would recover or recapture unreacted fuel gas which has previously passed through the individual ion exchange fuel cell modules 14. This system would separate the unreacted fuel gas and would return the unreacted fuel gas back to the individual ion exchange fuel cell modules 14 for further use. This recovery system would be coupled with a byproduct removal line (not shown).

The fuel cell power system is configured in a manner where at least one of the fuel cell modules 14 can be easily removed from at least one of the subracks by hand, while the remaining modules continue to operate. This removal is normally accomplished without the use of any tools, however it may be necessary in some commercial or industrial applications where vibration, and other outside physical forces may be imparted to the system, to use threaded fasteners and the like to releasably secure the individual modules to the subrack to prevent the unintentional displacement or dislocation of the respective modules from the subrack. If utilized, the hand tools which will be employed will be simple hand tools, and the removal will be accomplished in minutes, as opposed the prior art stack arrangements where replacement of a damaged membrane electrode assembly (MEA) may take hours to accomplish.

Each fuel cell cartridge 14 includes a plurality of membrane-electrode assemblies (MEAs). One fuel cell power system is described in detail in U.S. patent application Ser. No. 09/577,407, filed May 17, 2000, titled “Ion Exchange Membrane Fuel Cell, and Ion Exchange Membrane Fuel Cell Power System”, naming as inventors William A. Fuglevand, Peter D. DeVries, Greg A. Lloyd, David R. Lott, and John P. Scartozzi, and incorporated by reference herein.

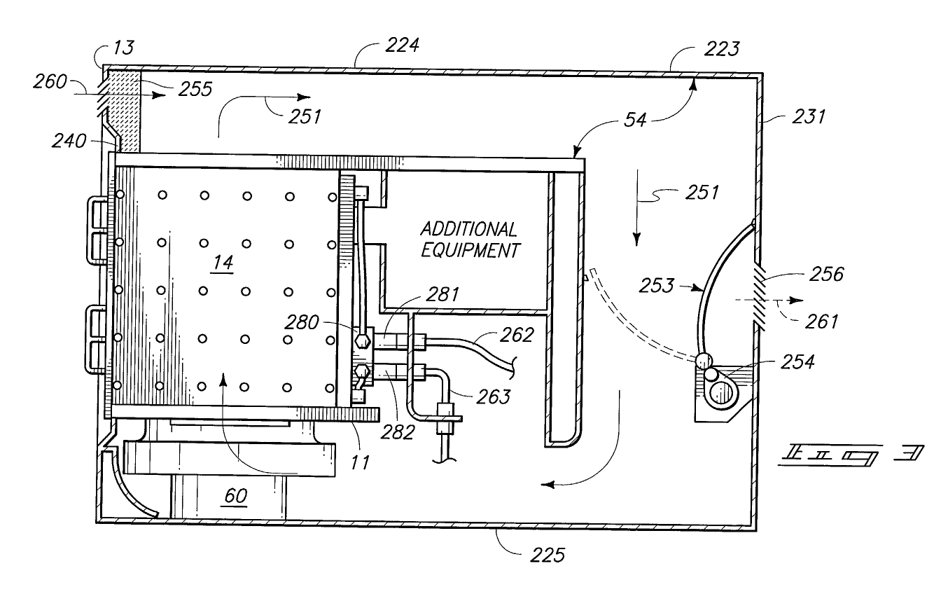

Referring to FIG. 2, some components of the fuel cell power system 10 are shown. The components are internal and external of the housing 12 of fuel cell power system 10. Internally, only three fuel cell cartridges 14 are shown in FIG. 2 for simplicity. More fuel cell cartridges 14 are provided in typical configurations.

The fuel cell power system 10 shown in FIG. 2 further includes a control system 20. One configuration of the control system 20 is described below in detail.

The control system 20 is coupled with the fuel cell cartridges 14 and with an operator interface 28. The operator interface 28 is used to command and control the fuel cell power system 10 and to communicate operational data to a user. The control system 20 is further coupled with a communication port 30, a switching device 32, and one or more current sensors 34. The control system 20 is additionally coupled with a bleed solenoid 36 associated with a bleed valve 38.

The control system 20 is coupled with the communication port 30 providing communications to an external device such as to a remote communications device 18 as seen in FIG. 2. An exemplary remote device comprises an external control system or monitoring system off-site from fuel cell power system 10. The control system 20 can output data including requests, commands, operational conditions, etc., of fuel cell power system 10 using the communication port 30. In addition, the control system 20 can receive data including commands, requests, etc., from the remote device using the communication port 30. Details of one control system 20 is described in U.S. patent application Ser. No. 09/322,666, filed May 28, 1999, entitled “Fuel Cell Power Systems and Methods of Controlling a Fuel Cell Power System”, naming William A. Fuglevand, P.E., Dr. Shiblihanna I. Bayyuk, Ph.D., Greg A. Lloyd, Peter D. Devries, David R. Lott, and John P. Scartozzi as inventors, assigned to the assignee hereof, and incorporated herein by reference.

The depicted fuel cell power system 10 includes a fuel delivery system 40. Fuel delivery system 40 couples with a fuel supply 42 to supply fuel to fuel cell cartridges 14. Exemplary fuel comprises hydrogen gas or hydrogen-rich gas in the described embodiment. Other fuel types used with fuel cells can be used in alternative embodiments.

The depicted fuel delivery system 40 includes a main fuel valve 44 and plural auxiliary fuel valves 46 associated with respective fuel cell cartridges 14. The main valve 44 controls the flow of fuel from fuel supply 42 to the auxiliary fuel valves 46. The auxiliary valves 46 control the flow of fuel to the respective fuel cell cartridges 14. The control system 20 is coupled with plural auxiliary solenoids 48 associated with auxiliary fuel valves 46. The control system 20 is further coupled with a main solenoid 50 associated with the main fuel valve 44.

The depicted fuel cell power system 10 includes an air temperature control assembly 52. The illustrated air temperature control assembly 52 includes a plenum 54 having associated ports 56 corresponding to fuel cell cartridges 14. Within the plenum 54 of the air temperature control assembly 52, a temperature modifying element 58, a fan 60, a temperature sensor 62, and a fuel sensor 64 are provided.

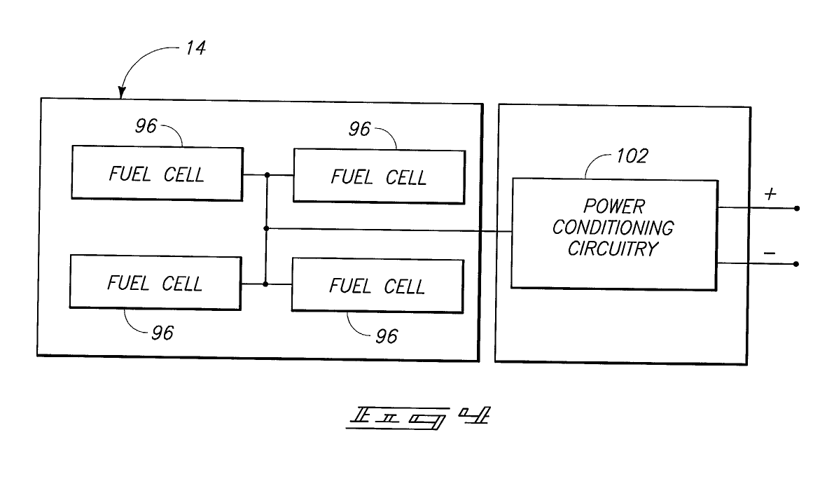

A controllable air flow device or air passage 66 couples the plenum 54 to exterior ambient air outside of housing 12. The air passage 66 can permit the intake of air into the plenum 54 as well as the exhaustion of air from plenum 54. The control system 20 is coupled with control circuitry 68 associated with the modifying element 58, control circuitry 70 and monitoring circuitry 72 associated with the fan 60, temperature circuitry 74 associated with the temperature sensor 62, control circuitry 76 of air passage 66, heater 77 of fuel sensor 80, and heater 78 of fuel sensor 64. As will be discussed in greater detail hereinafter and as seen in FIG. 3, a selectively moveable vane 253 is provided and which is operable to selectively occlude the air plenum 54 for purposes of controlling the operating temperature of the module 14.

A fuel sensor 80 is provided outside of the plenum 54. The fuel sensor 64 is provided within the plenum 54 to monitor for the presence of fuel within plenum 54. The control system 20 is configured to couple with fuel detection circuitry 82 associated with the fuel sensors 80, 64. The fuel detection circuitry 82 is used, in one embodiment, to condition measurements obtained from the sensors 80, and 64.

The heaters 77, 78 are coupled with respective fuel sensors 80, 64 to provide selective heating of the fuel sensors 80, 64 responsive to control from the control system 20. The heaters 77, 78 are integral of fuel sensors 80, 64 in some configurations. An exemplary fuel sensor configuration with an integral heater has designation TGS 821 available from Figaro Engineering, Inc. Such heaters are used with the sensors 80, 64 as known in the art. Other configurations of sensors 80, 64 are possible.

An external temperature sensor 84 is provided outside of the housing 12 in one embodiment. The control system 20 is coupled with temperature circuitry 86 associated with temperature sensor 84 to monitor the exterior temperature. The temperature circuitry 86 conditions signals received from the temperature sensor 84.

The control system 20 is configured to control and/or monitor at least one operation of the fuel cell power system 10. During operation, fuel from fuel supply 42 is applied to the main fuel valve 44. The main fuel valve 44 is coupled with the auxiliary fuel valves 46 as shown. Responsive to control from control system 20, main valve 44 and auxiliary valves 46 apply fuel to respective fuel cell cartridges 14. Responsive to the supply of fuel, and in the presence of oxygen, fuel cell cartridges 14 produce electrical power.

A power bus 88 couples the fuel cell cartridges 14 in series, in parallel, or a combination of series and parallel connections. The power bus 88 provides an electrical connection which is coupled with external terminals 90, 92 which may be connected with an external load 94 (shown in FIG. 1). Terminal 90 is a positive terminal and terminal 92 is a negative terminal.

An air temperature control assembly 52 applies oxidant and cooling air to the respective fuel cell cartridges 14 via ports 56. The fuel cell cartridges 14 are individually operable to convert chemical energy into electricity. As described below, the fuel cartridges 14 individually contain plural fuel cells individually having an anode side and a cathode side. Auxiliary valves 46 apply fuel to the anode sides of the fuel cells. Plenum 54 directs air within the cathode sides of the fuel cells.

The air temperature control assembly 52 provides circulated air that is maintained, in one embodiment within a predetermined temperature range. The circulated air can be exterior air and/or recirculated air. In one embodiment, the air temperature control assembly 52 provides air within plenum 54 within an approximate temperature range of 25° Celsius to 80° Celsius.

Upon start-up conditions of fuel cell power system 10, the modifying element 58 may be controlled via the control system 20 using the element control circuitry 68 to either increase or decrease the temperature of air present within the plenum 54. The fan 60 operates to circulate the air within the plenum 54 to respective fuel cell cartridges 14. The fan control circuitry 70 and the fan monitor circuitry 72 are shown coupled with the fan 60. Responsive to control from control system 20, the fan control circuitry 70 operates to control air flow rates (e.g., speed of rotation) of the fan 60. The fan monitor circuitry 72 operates to monitor the actual air flow rates induced by the fan 60 (e.g., the circuitry 72 can comprise a tachometer for rotational fan configurations).

In one embodiment, the control system 20 monitors the speed of the fan 60, via the fan monitor circuitry 72, and provides a signal indicating an error condition if the speed of the fan exceeds a certain amount and/or the speed of the fan is below a certain amount. In response to this fan speed error conditions, the control system can control one or more operational aspects of the fuel cell power system to, for example, perform one or more of the following: shut the main valve 44 to prevent fuel from reaching the cartridges 14, shut the auxiliary valves 46 to prevent fuel from reaching the cartridges 14, disconnect the fuel cell power system 10 from a load 94, or disconnect the fuel cell cartridges 14 from the power bus 88.

The control system 20 monitors the temperature of the air within the plenum 54 using a temperature monitor or sensor 62. In one embodiment, redundant temperature sensors 62 are provided to monitor the temperature of each cartridge 14. In one embodiment, the temperature sensors 62 are thermocouples mounted to the housings of cartridges 14 themselves. During operation, heat is generated and emitted from the fuel cell cartridges 14. Thus, it may be necessary to decrease the temperature of air within the plenum 54 to provide efficient operation of fuel cell power system 10. Responsive to control from the control system 20, the air passage 66 can be utilized to introduce exterior air into the plenum 54 and exhaust air from the plenum 54 to ambient. In one embodiment, the control system 20 controls air flow in response to the temperature of the hottest cartridge 14. In an alternative embodiment, the control system 20 controls air flow in response to plenum temperature.

The control system 20 communicates with the control circuitry 76 to control the air passage 66. In one embodiment, the air passage 66 includes one or more vanes or shutters, and the control circuitry 76 operates to control the position of the vanes or shutters to selectively open or close the air passage 66, affecting flow of exterior air into the plenum 54 or air out of the plenum 54. The vanes of the air passage 66 can preferably be provided in a plurality of orientations between an open position and a closed position to vary the amount of exterior fresh air introduced into the plenum 54 or the amount of air exhausted from the plenum 54 responsive to control from the control system 20. Air circulated within the plenum 54 can comprise recirculated and/or fresh ambient air.

Utilizing the temperature sensor 84, the control system 20 can also monitor the temperature of intake air into the plenum 54 or ambient air outside of housing 12. The control system 20 can utilize such temperature information from the temperature sensor 84 to control the operation of air passage 66. The temperature sensor 84 is located adjacent air passage 66 in one embodiment.

As described in further detail below, the control system 20 controls air flow rates of the fan 60 using fan control circuitry 70. The fan monitor circuitry 72 provides air flow rate information to the control system 20. Additionally, the position of the vane 253 is also monitored by the control system 20. For example, the control circuitry 76 includes a vane position sensor, in one embodiment. Current flowing to the power bus 88 can be calculating by using current sensor 34. In one embodiment, a current sensor 34 is provided for each cartridge 14, and the control system 20 monitors current from each cartridge 14. With knowledge of the system bus current and load, the control system 20 can calculate waste thermal power and provide a desired cooling air flow.

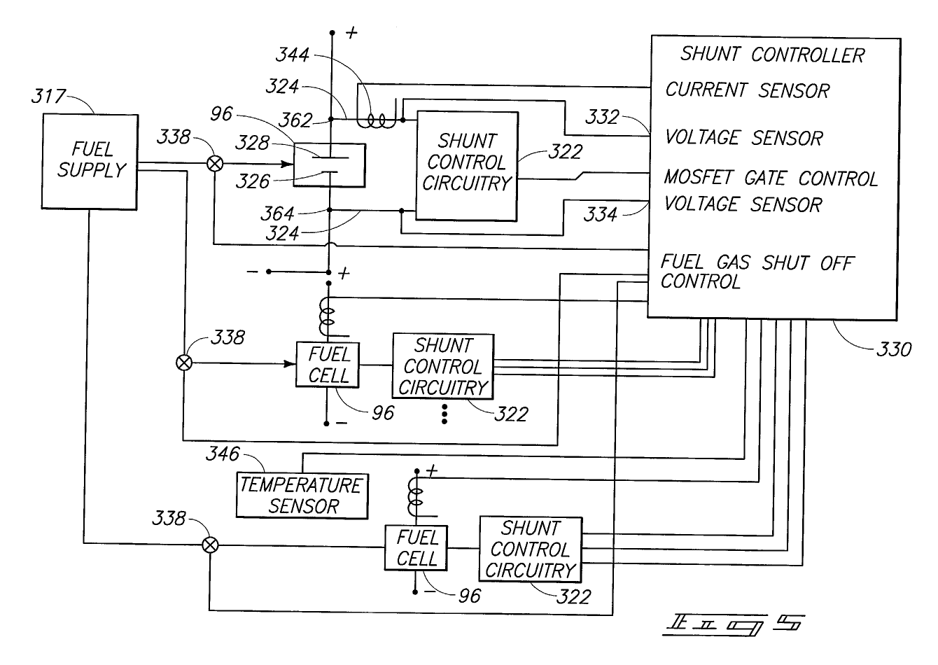

More specifically, the efficiency of one or more fuel cells may be determined by dividing the respective fuel cell voltage by 1.23 (a theoretical maximum voltage of a single fuel cell). Each cartridge 14 includes a plurality of fuel cells 96 (FIG. 4). Each fuel cell 96 has an anode side, a cathode side, and a membrane electrode assembly between the anode side and the cathode side. An average efficiency can be determined for fuel cells 96 of fuel cell power system 10. The remaining energy (energy not associated to electricity) as determined from the efficiency calculation is waste thermal power. The determined waste thermal power may be utilized to provide a desired cooling air flow. The control system 20 controls the air flow rates of the fan 60 depending upon the waste thermal power in accordance with one aspect of the described fuel cell power system 10.

During operation of fuel cell cartridges 14, non-fuel diluents such as cathode-side water and atmospheric constituents can diffuse from the cathode side of the fuel cell through a membrane electrode assembly of the fuel cell and accumulate in the anode side of the fuel cell 96. In addition, impurities in the fuel supply delivered directly to the anode side of the fuel cell also accumulate. Without intervention, these diluents can dilute the fuel sufficiently enough to degrade performance. Accordingly, the anode side of the individual fuel cells 96 is connected to a bleed manifold 98. Bleed manifold 98 is additionally coupled with the bleed valve 38.

The control system 20 selectively operates the bleed solenoid 36 to selectively open and close the bleed valve 38 permitting exhaustion of matter such as entrained diluents and perhaps some fuel via a bleed exhaust 100 within housing 12. The control system 20 can operate to open and close bleed valve 38 on a periodic basis. The frequency of openings and closings of bleed valve 38 can be determined by a number of factors, such as electrical load coupled with terminals 90, 92, etc. Although not shown, a fuel recovery system may be coupled with bleed exhaust 100 to recover unused fuel for recirculation or other uses.

Following a start-up condition either inputted via interface, the control system 20 selectively controls the switching device 32 to couple power bus 88 with positive terminal 90. The switching device 32 can comprise parallel MOSFET switches to selectively couple positive and negative terminals 90 and 92 to the cartridges 14.

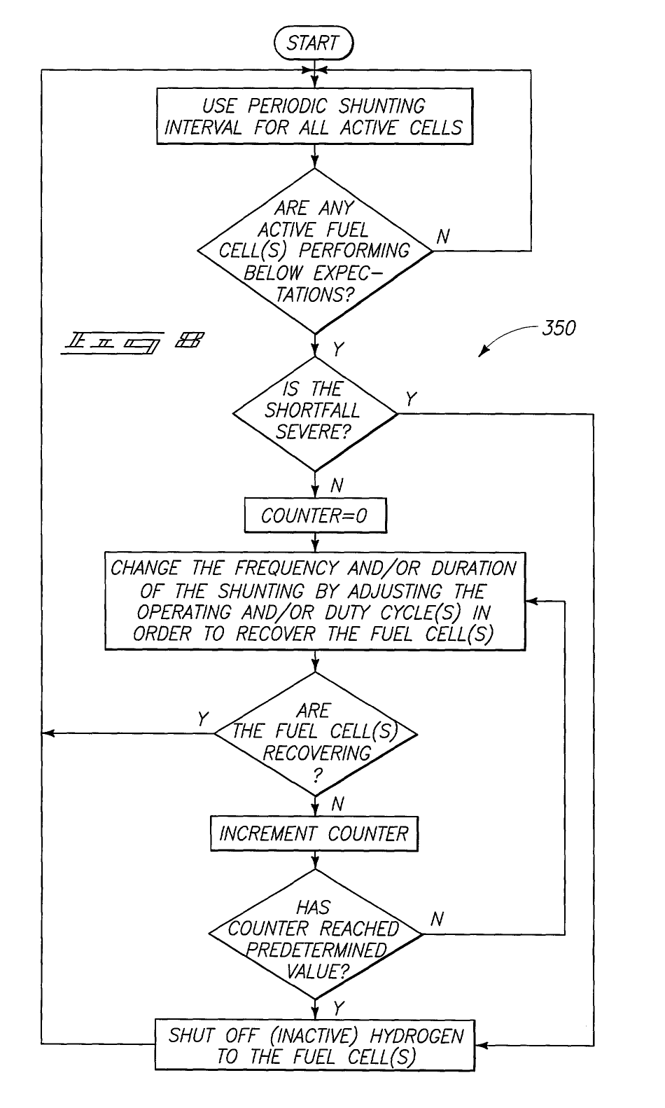

For example, the control system 20 may verify when an appropriate operational cartridge temperature has been reached, utilizing temperature sensor 62. In addition, the control system 20 can verify that at least one electrical characteristic, such as voltage and/or current, of respective fuel cell cartridges 14 has been reached before closing switching device 32 to couple power bus 88 with a load 94 (FIG. 6). Such provides proper operation of the fuel cell power system 10 before coupling the bus 88 with an external load 94.

Referring now to FIG. 3, a longitudinal, vertical, sectional view of housing 12 is shown, and wherein a fuel cell module 14 is supported on a subrack 11. As seen in this sectional view, fan 60 is supported within the principal enclosure 13. The fan provides an air flow 251 across and/or through the modules 14. The air flow 251 provides both heat dissipation and/or cooling, and an oxidant supply for the fuel cell modules 14 during operation. The subrack 11 and the principal enclosure 13 further define plenum 54. A moveable vane or air valve 253 is provided within the air plenum. An actuator 254 is also provided which moves the vane into an appropriate orientation relative to the air plenum 54. An air filter 255; and an exhaust vent 256 is provided and are formed in the rear sidewall 231 as seen in FIG. 3. In the embodiment shown in FIG. 3, the air filter 255 and exhaust 256 together define the air passage 66 illustrated in FIG. 2. As illustrated, intake air which is generally indicated by the numeral 260 enters the subrack 11 or principal enclosure 13, through the air filter 255 and travels along the air plenum 54. In an alternative embodiment, a single air passage is used for both intake and exhaust. The actuator 254, as noted above, angularly positions the vane or air valve 253 within the internal air plenum 54 such that exhaust air 261 exits through vent 256 or is repeatedly recycled in whole or in part through the several modules 14. Fuel 21 is supplied to module 14 through the conduit labeled 262 as seen in FIG. 3. Further, waste water is exhausted through conduit 263. Suitable electrical connections (not shown) are further provided so that electrical current may be delivered through external circuitry which will be discussed in greater detail hereinafter. The fuel cell power system 10 has at least one ion exchange membrane fuel cell module 14 which produces heat energy during operation. The air flow 251 is delivered to each of the modules 14 where it is further bifurcated to dissipate the heat energy which is generated during operation. In this regard, one portion of the air flow passes through the respective modules and another portion passes over the outside thereof.

Power conditioning circuitry 102 is illustrated coupled with bus 88 in the configuration depicted in FIG. 4, but is omitted in other embodiments. The power conditioning circuitry 102 is configured to receive and condition direct current electrical energy received from fuel cells within cartridges 14. Power conditioning circuitry 102 is provided inside or outside respective cartridges 14 to condition the electrical energy applied to bus 88 in some configurations, in a manner such that disclosed in U.S. patent application Ser. No. 09/322,666, filed May 28, 1999, entitled “Fuel Cell Power Systems and Methods of Controlling a Fuel Cell Power System”, naming William A. Fuglevand, P.E., Dr. Shiblihanna I. Bayyuk, Ph.D., Greg A. Lloyd, Peter D. Devries, David R. Lott, and John P. Scartozzi as inventors, assigned to the assignee hereof, and incorporated herein by reference.

Referring to FIG. 4, an exemplary fuel cell cartridge 14 comprises one or more fuel cells 96 coupled with power conditioning circuitry 102. Fuel cells 96 of each cartridge may be coupled in either series or parallel, or a combination of series and parallel connections, with power conditioning circuitry 102. Exemplary power conditioning circuitry 102 comprises a controller and memory as described in U.S. patent application Ser. No. 09/987,225, filed Nov. 14, 2001, entitled “Fuel Cell Power Systems and Methods of Operating Fuel Cell Power Systems”, naming Timothy J. Schmidt, Peter D. DeVries, and Jonathan Dodge as inventors, assigned to the assignee hereof, and incorporated by reference herein, but which in one embodiment further provides additional functionality as described below.

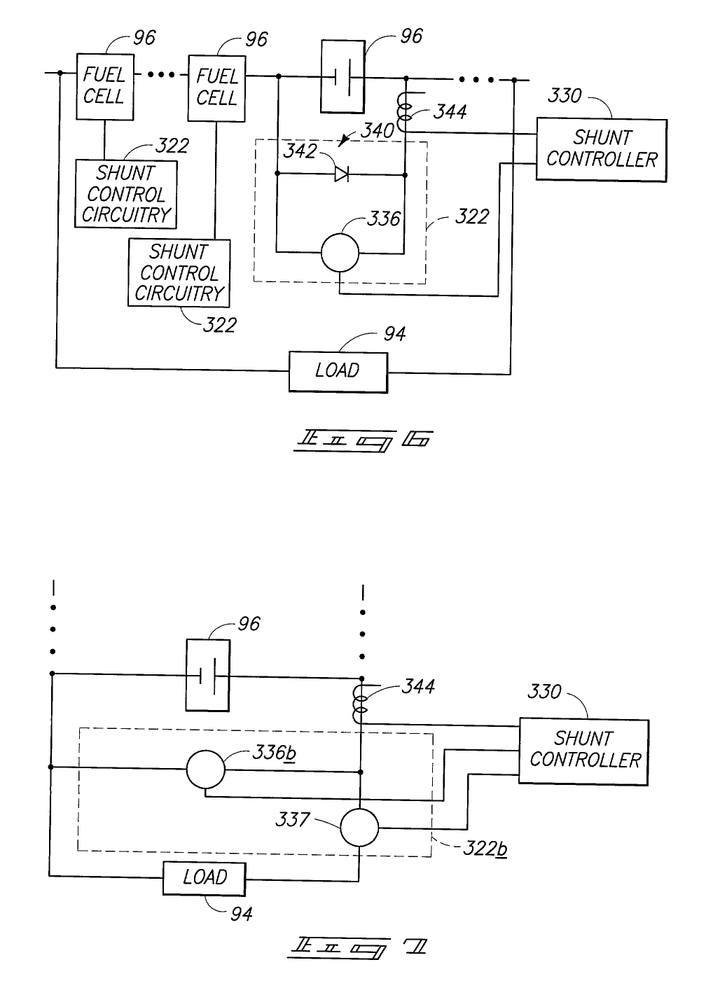

Referring now to FIG. 5, a plurality of fuel cells 96 are shown configured to produce electrical current having a given voltage and current output. In the embodiment shown in FIG. 5, only a few fuel cells 96 are illustrated, for simplicity. However, in actuality, a plurality of fuel cells 96 are provided which can be coupled together in series, parallel, or combination series/parallel arrangements. More particularly, one or more fuel cells 96 are contained in each cartridge 14 in series, parallel, or a series/parallel combination.

The power system 10 includes shunt control circuitry 322 shown in FIG. 5. There are multiple alternative forms of shunt control circuitry 322. Alternative embodiments of shunt control circuitry 322 are described below. The shunt control circuitry 322 includes an electrical path 324 which electrically couples the anode 326 and cathode 328 of one of the fuel cells together. In one embodiment, shunt control circuitry 322 is provided for each fuel cell 96.

The power system 10 further includes a shunt controller 330 which is included in or in communication with the control system 20 of FIG. 2. In one embodiment, all of the shunt control circuits 322 of the fuel cell power system 10 are electrically coupled to a common shunt controller 330; alternatively, multiple shunt controllers 330 can be employed. In one embodiment, the shunt controller 330 may be purchased through conventional retail sources. A suitable controller 330 for this application is the programmable microcontroller chip having the trade designation MC68HC908AZ60, and which may be utilized to perform the program logic described below.

As seen in FIG. 5, the shunt controller 330 includes or is coupled to a pair of voltage sensor electrodes or inputs (or a pair of voltage sensors) 332 and 334 for each fuel cell 96 and which are electrically coupled with the anode 326 and cathode 328, respectively, to sense the voltage at the anode and cathode 326 and 328 of the fuel cell 96.

The power system 10 further includes a current sensor 344 electrically coupled between the shunt controller 330 and each fuel cell cartridge 14 for use by the shunt controller 330 in detecting current flowing from the fuel cell cartridge 14. In one embodiment, the current sensor is in the form of a current shunt that detects current flowing from the fuel cell 96 without direct electrical connection to the fuel cell 96. In another embodiment, the current sensor is a current transformer. Other types of current sensors known in the art could also be employed. In one embodiment, one current sensor 34 (see FIG. 2) or 344 is provided for each cartridge 14, one is provided on the cartridge bus (total out of all cartridges), one is provided on the load side of a DC-DC converter coupled to the outputs 90 and 92 of FIG. 2, and another is provided on a battery for managing battery charging of the battery (not shown). In one embodiment, a battery is used for supplying power to the control system 20 before start-up of the fuel cells. In one embodiment, the current sensors 344 and voltage sensors 332 are separate from the shunt controller 330, though the shunt controller 330 includes circuitry used in reading the current and voltage sensors; however, in alternative embodiments, some or all of the voltage and current sensors are included in the shunt controller 330.

The fuel cell power system 10 further includes fuel shut-off valves 338 which are disposed in fluid metering relation relative to the fuel 21. The shunt controller 330 is electrically coupled in controlling relation relative to the valves 338.

The fuel cell power system 10 includes a temperature sensor 346 for sensing the temperature of one or more fuel cells. For example, two temperature sensors can be provided per cartridge 14, as described above, supported by the housing, such as inside the apertures 16 (see FIG. 1), or temperature sensors can be included in the cartridges 14 and coupled by a connector to the shunt controller 330, or temperature sensor can be provided for groups of fuel cells in various locations in the housing 12.

Each fuel cell 96 produces electrical power having a given current and voltage output. The controller 330 is electrically coupled with the fuel cells 96 and is operable to shunt the electrical current between the anode 326 and the cathode 328 of a fuel cell 96 under predetermined operational conditions.

In one embodiment, as will be described below in further detail, the controller 330 upon sensing, by way of the voltage and current sensors 332, 334, and 344, a given voltage and current output of a fuel cell 96, adjusts the valve 338 associated with that fuel cell 18 into a predetermined fluid metering relationship relative to the fuel 21.

FIG. 6 shows construction details of shunt control circuitry 322, in accordance with one embodiment of the invention. The shunt control circuitry 322 includes an electrical switch 336, here shown as being a field effect transistor of conventional design. A suitable commercially acceptable MOSFET may be obtained from Mitsubishi, designated FS100UMJ. The shunt controller 330 is electrically coupled to the control electrode (e.g., gate) of the electrical switch 336.

The shunt control circuitry 322 includes bypass electrical circuitry 340 which further electrically couples the anode and cathode 326 and 328 (see FIG. 6) of each of the fuel cells 96 together. The bypass electrical circuitry comprises a diode 342. The bypass electrical circuitry 340 is operable to provide a current flow path from the anode to cathode of a fuel cell 96 upon failure of the shunt controller 330. In the event that the shunt control circuitry 322 fails in conjunction with a failing fuel cell 96, the bypass electrical circuitry 342 prevents fuel cell damage from occurring. The diode 342 is normally reverse biased when the associated fuel cell 96 is producing power, and it has no effect on the shunt control circuitry 322 under normal operational conditions. As the voltage output of a failing fuel cell 318 nears 0 or becomes negative, the diode 342 becomes forward biased. Current can then travel through the diode 342 instead of the fuel cell 96. The maximum negative voltage depends upon the type of diode selected. A Schottky barrier diode which is commercially available as 85CNQ015, is employed, in one embodiment. This model diode allows high current to flow at approximately 0.3 volts. This voltage limitation limits the maximum negative voltage of the fuel cell thereby preventing overheating and subsequent damage.

The field effect transistor 336 has open and closed electrical conditions. The controller 330 positions the field effect transistor in an open or closed electrical condition, based upon predetermined performance parameters for the respective fuel cells 96.

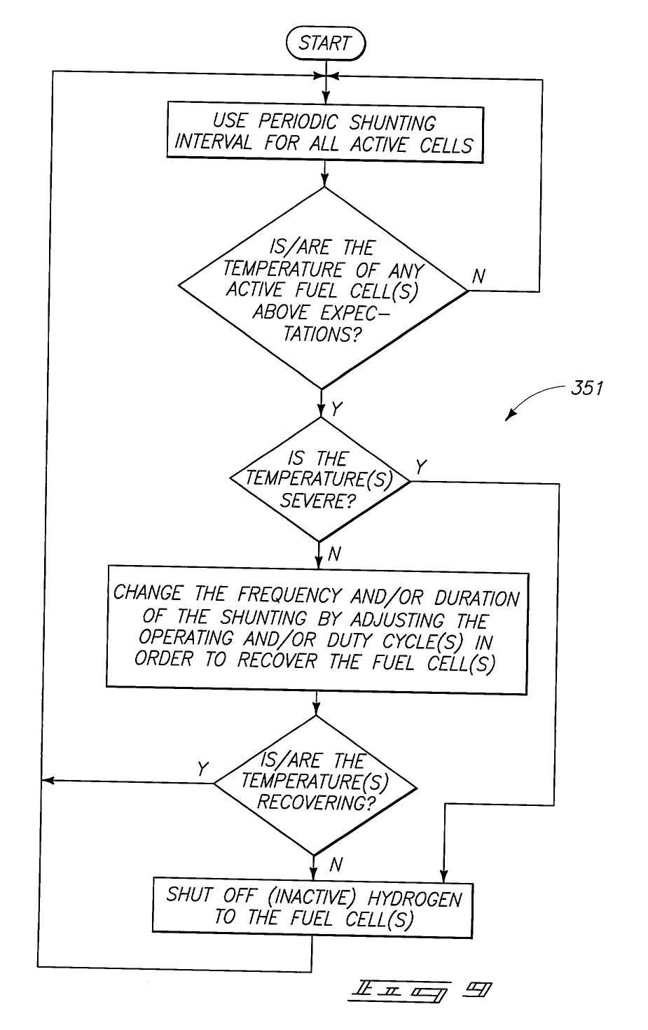

FIG. 7 shows shunt control circuitry 322b that is used in place of the shunt control circuitry 322 of FIG. 6, in an alternative embodiment. More particularly, the circuitry 322b of FIG. 7 is well suited for power systems 10 including fuel cells arranged in parallel. The control circuitry 322b includes a switch 336b, that is substantially similar to the switch 336 of FIG. 6, in parallel with the load 94. The switch 336b has open and closed electrical conditions. The controller 330 selectively opens or closes the switch 336b. The control circuitry 322b further includes a switch 337 that is substantially similar to the switch 336 of FIG. 6, in series with the load 94. The switch 337 has open and closed electrical conditions. The controller 330 selectively opens or closes the switch 337.

The field effect transistor has open and closed electrical conditions. The controller 330 positions the field effect transistor in an open or closed electrical condition, based upon predetermined performance parameters for the respective fuel cells 96.

In a first operational condition where a given fuel cell is performing at or below predetermined performance parameters or expectations, the controller 330 is operable to simultaneously cause the valve 38 for that fuel cell to assume a position where it terminates the supply of fuel gas to the fuel cell 96 and places the electrical switch 336 in a closed electrical condition thereby shorting the anode 326 to the cathode 328. This substantially prevents heat related damage from occurring to the fuel cell 96 as might be occasioned when the negative hydration spiral occurs.

Referring to FIG. 2, if the electrical switch 336 is subsequently placed in the open position, the controller 330 is operable to cause the valve 38 to be placed in a condition which allows the substantially continuous supply of fuel gas to the fuel cell.

When the voltage output of the fuel cell 96 is less than about 0.4 volts, the electrical switch assumes a closed position thereby shorting the anode to the cathode, while simultaneously causing the valve to terminate the supply of fuel gas. A negative hydration spiral can result in excessive heat which causes damage to the MEA. In this first operational condition, the shunt control circuitry 322 is operable to pass the current thereby preventing this damage. Of course, the performance parameters which may trigger the first operational condition can include declining performance parameters; or declining performance parameters in relative comparison to the performance parameters being achieved by other fuel cells 96. Still other parameters not listed herein could also be used.

In a second operational condition, the shunt control circuitry 322 is operable to increase the resulting electrical power output of the fuel cell 96. The fuel cells 96 have predetermined performance parameters comprising selected current and voltage outputs of the fuel cell 96. In the second condition, and where the performance parameters may be merely declining and have not decreased below a minimum threshold, the shunt control circuitry 322 is employed in an effort to restore individual and groups of fuel cells 18 to the given performance parameters. For example, the voltage and current output of one or more fuel cells 18 may begin to decline. As this decline is detected by the shunt controller 330, the controller 330 controls the shunt control circuitry 322 to repeatedly short between the anode and cathode of the degraded performance fuel cells 96 at individually discrete rates which are effective to restore the fuel cells to the predetermined performance parameters. In another example, where the performance parameters may be merely declining, the controller 330 is effective to adjust the duty cycle of individual fuel cells 96 by reference to the declining performance parameters of the fuel cell in relative comparison to the performance parameters of other fuel cells to improve the electrical performance of same.

In the first and second operational conditions, the predetermined performance parameters of the individual and serially electrically coupled fuel cells 96 comprise selected current and voltage outputs of the fuel cell 96. These predetermined threshold performance parameters may be determined by various means including but not limited to, experiment; operational history or electrical load, for example. Additionally, the predetermined performance parameters might include, in the first condition, for example, where the performance parameters of the fuel cell are just merely or generally declining over a given time interval; or are declining or degrading, generally speaking in relative relation to the performance parameters of other fuel cells 96 with which it is parallely electrically coupled. In one embodiment, a given fuel cell is consider to be performing at or below predetermined parameters if the current drops below 300 mA/cm2 at 0.6 Volts, for example.

The term “duty cycle,” as utilized hereinafter, means the ratio of the “on time” interval occupied in operating a device to the total time of one operating cycle (the ratio of the pulse duration time to the pulse-repetition time). Another way of defining the term duty cycle is the ratio of the working time to the total operating time for intermittent operating devices. This duty cycle is expressed as a percentage of the total operating cycle time. In the embodiment of FIG. 5, therefore, the shunt control circuitry 330 is operable to adjust both the duration of the shorting, as well as the operating cycle time as to selective fuel cells in order to restore or maintain the fuel cells above the predetermined performance parameters selected.

Enhanced fuel cell performance can be achieved by adjustably, repeatedly shorting the anode 326 and cathode 328 of the fuel cell 96. In this regard, and in the second operational condition, the programmable logic as shown at 350 in FIG. 8 is utilized by the shunt controller 330 to individually, adjustably and periodically open and close each of the electrical switches 336 that are individually electrically coupled and associated with each of the fuel cells 96. These electrical switches 336 may be activated individually, serially, in given groups, or patterns, or in any fashion to achieve the predetermined voltage and current output desired. In this regard, it has been determined that operating cycle time of about 0.01 seconds to about four minutes produces good results, in one embodiment. When this periodic shorting is implemented, it has been discovered that the voltage output of the fuel cells 96 can increase by at least about 5%. Still further, the shunt control circuitry 330 is operable to shunt the electrical current for a duration of less than about 20% of the operating cycle.

During the second operational condition, the shunt controller 330 causes the valve 338 to remain in a condition which allows the substantially continuous supply of fuel gas to the associated fuel cell 96 during shorting. It is speculated that this repeated, and periodic shorting causes each of the shunted fuel cells 96 to be “conditioned”, that is, such shorting is believed to cause an increase in the amount of water that is made available to the MEAs of the fuel cells thereby increasing the MEAs performance. It is also conceivable that the shorting provides a short term increase in heat dissipation that is sufficient to evaporate excess water from the diffuser layers which are mounted on the MEA. This evaporation of water would make more oxygen from the ambient air available to the cathode side of the MEA. Whatever the exact cause, the shunting appears to increase the proton conductivity of the MEA. This increase in proton conductivity results in a momentary increase in the power output of the fuel cell which diminishes slowly over time. The overall increase in the electrical power output of the fuel cell 96, as controlled by the adjustably sequential and periodic shorting of individual, and groups of fuel cells 96, results in the entire group of fuel cells increasing its overall power production. The respective shunt control circuits 322 are individually operably connected with each fuel cell 96, and can be rendered operable for single fuel cells, and groups of fuel cells. Additionally, the duty and operating cycles of the respective fuel cells 96 may be adjusted in any number of different combinations and for individually discrete durations, depending upon the performance of the individual fuel cells, to boost the performance of same; or for purposes of stabilizing the decreasing performance of a given group of fuel cells or individual fuel cells as the case may be.

In the second operational condition, the shunt controller 330, by implementing the logic shown in FIG. 8 at numeral 350 shorts between the anode 326 and cathode 328 of a fuel cell 96 when the associated electrical switch 336 is in the closed condition, while simultaneously maintaining the valve 338 in a condition which allows the substantially continuous delivery of fuel gas to the fuel cell 96 as the shunt controller periodically opens and closes the electrical switch. The fuel cell 96 has a duty cycle; and an operating cycle of about 0.01 seconds to about 4 minutes. The shorting by opening and closing the electrical switch 336 during the duty cycle increases the overall electrical power output of the fuel cell 96. The duration of the shorting during the duty cycle is less than about 20% of the operating cycle, in one embodiment.

In one embodiment, shown in FIG. 9, shorting of a fuel cell 96 is controlled in response to temperature sensed by the temperature sensor 346 arranged in temperature sensing arrangement to that fuel cell 96. For example, duty cycle, timing or duration of shorting is adjusted to optimize hydration or increase fuel cell output as indicated by logic 351. If temperature of a fuel cell increases beyond a nominal operating temperature, it can be assumed that hydration is decreasing, so shorting frequency and/or duration is decreased. In one embodiment, duty cycle of shorting is adjusted to attempt to equalize the temperature and output of each cartridge; thus, in this embodiment, at least one temperature sensor is provided in temperature sensing relation to each cartridge (redundant temperature sensors are provided on each cartridge in one embodiment).

FIG. 10 illustrates logic performed by the shunt controller 30 in another alternative embodiment. Block 352 represents an outer control loop. In block 352, temperatures of cartridges 14 are measured by respective temperature sensors 346, and the highest temperature is controlled to a value that is a function of output current (determined using one or more current sensors 344) of the entire cartridge bus, considered collectively.

In block 353, current produced by each cartridge 14 is measured. Lower temperature cartridges tend to produce less current.

In block 354, shorting duty cycle is increased for one or more of the coldest or lowest current output cartridges 14 (or poorest performing cartridge determined by considering both temperature and current). In one embodiment, only duration of shorting is increased. In one embodiment, duty cycle is increased for all cartridges that are at a temperature and/or current that is below a predetermined threshold. In one embodiment, shorting normally occurs for, for example, 120 milliseconds every 12 seconds. In block 354, shorting duration for each shunting operation can be increased, for example, by 100 milliseconds (e.g. approx. 83 percent) for all cartridges that are at a temperature and/or current that is below a predetermined threshold; in another embodiment, duration is increased for only the single coldest and/or lowest current output cartridge. Other size steps, such as 10, 20, 50, or 100 percent increases in short duration are employed in alternative embodiments.

In one embodiment, block 354 additionally includes decreasing the duty cycle of one or more of the warmest or highest current output cartridges 14 in a manner similar to that in which duty cycle is increased for the coldest or lowest current output cartridges.

In block 355, there is a delay to wait for the current of the designated one or more of the coldest or lowest current output cartridges 14 to improve. After current output improvement of a predetermined percentage or to a predetermined current level is detected, duty cycle is decreased by a predetermined amount or percentage, such as by reducing duration of shorting by 10, 20, 50, or 100 percent, for example.

Temperature should fall in range with a slight phase lag (e.g., one minute) behind current. Therefore, in one embodiment, duty cycle is decreased in block 355 when temperature improvement of a predetermined percentage or to a predetermined level of temperature level is detected, instead of current output improvement.

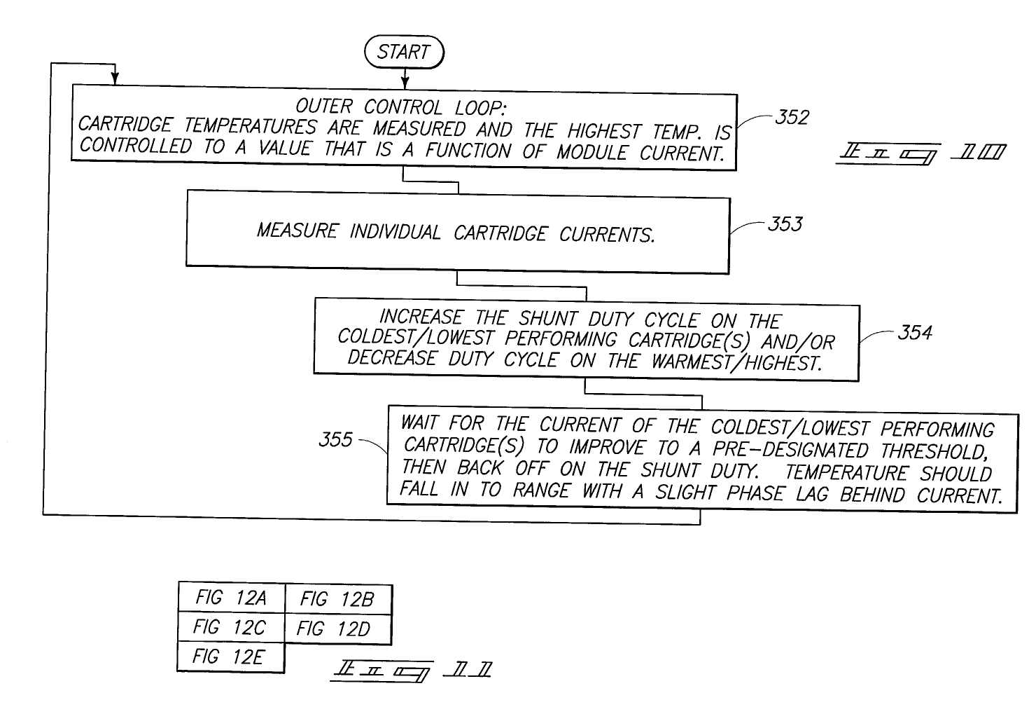

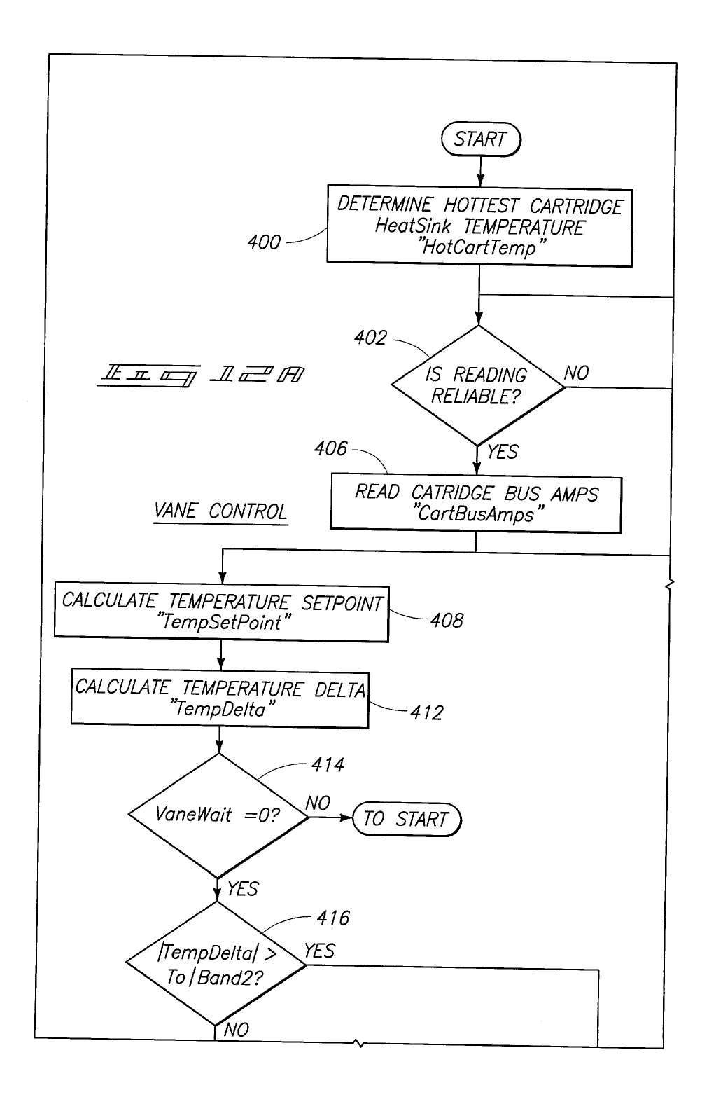

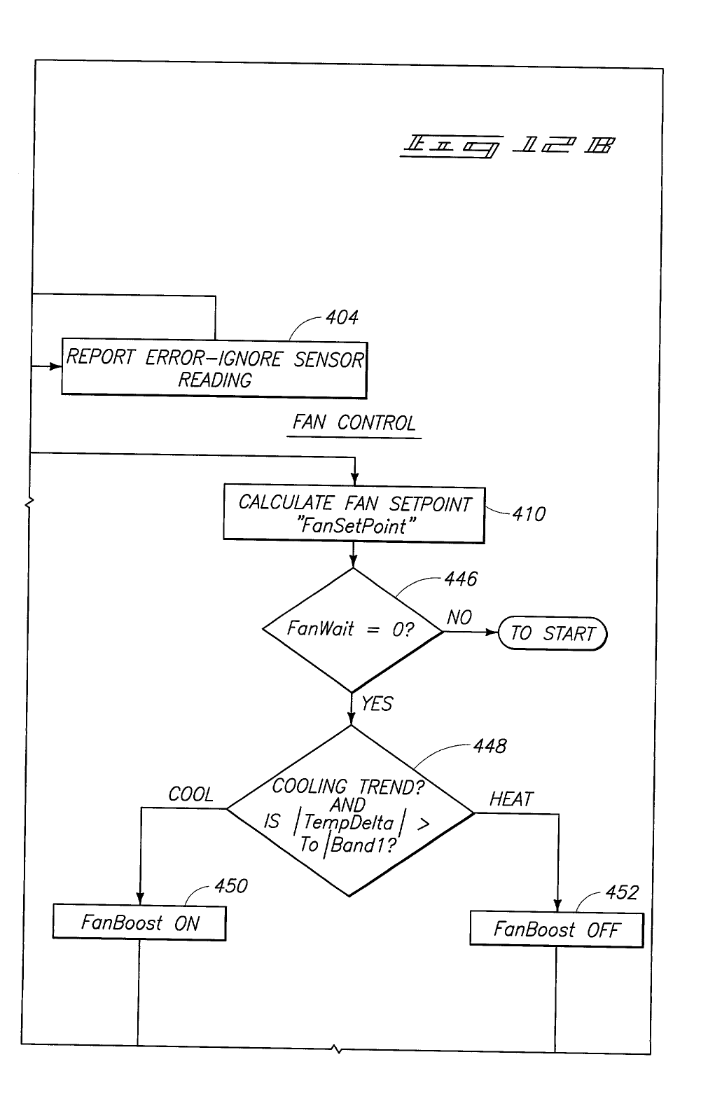

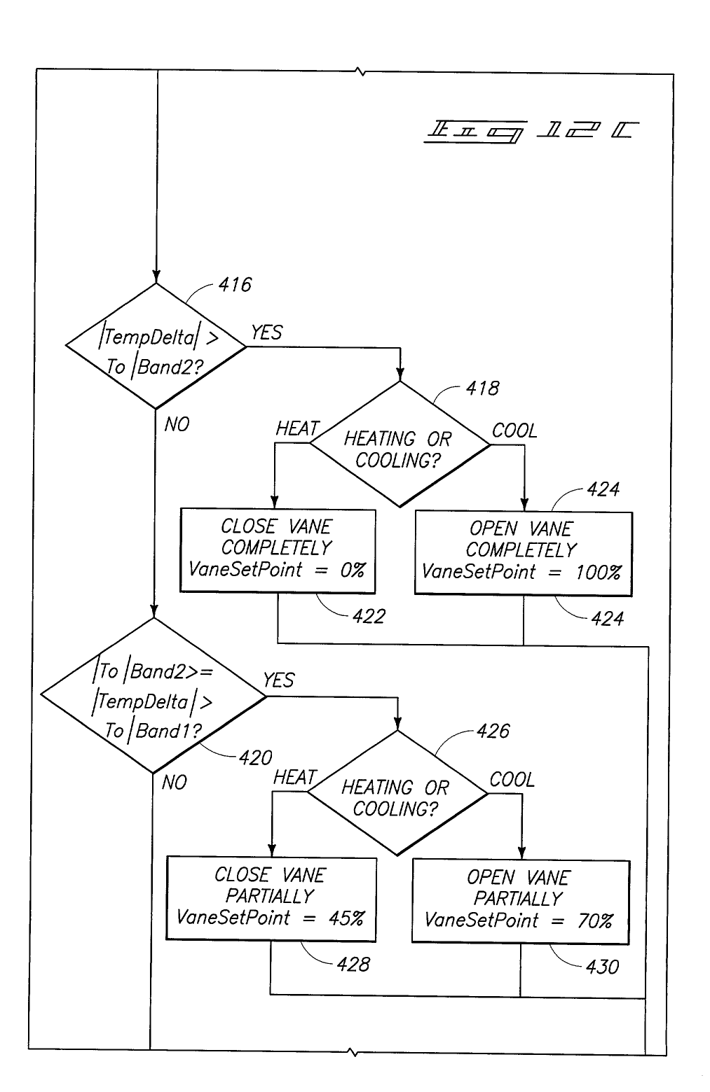

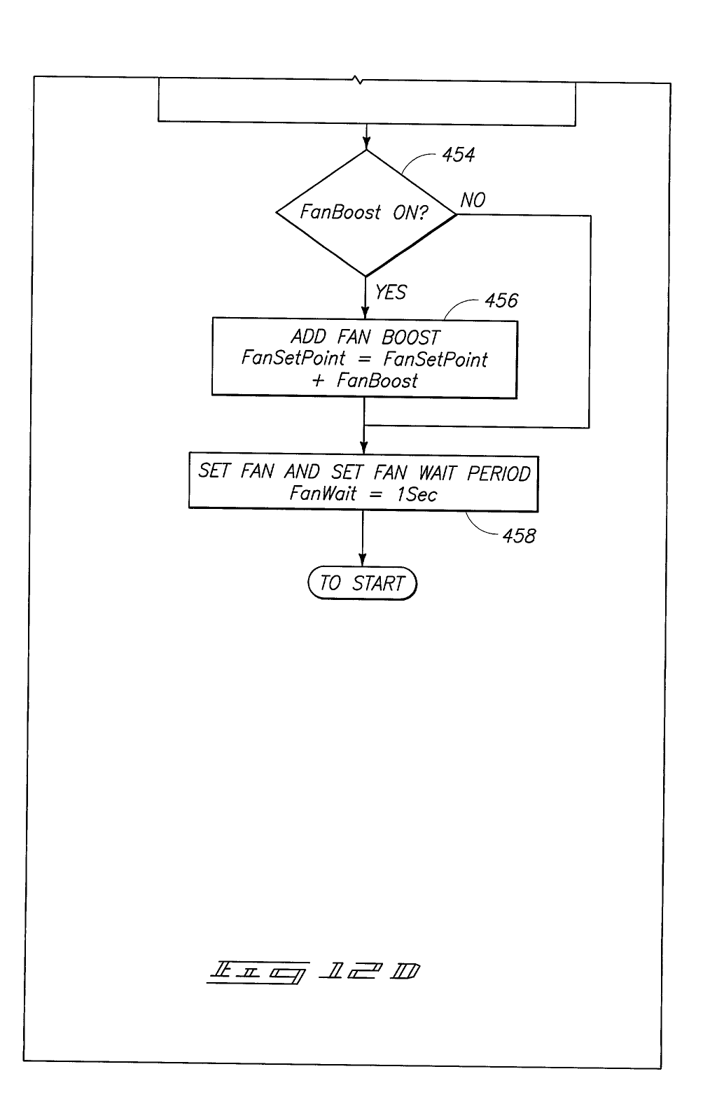

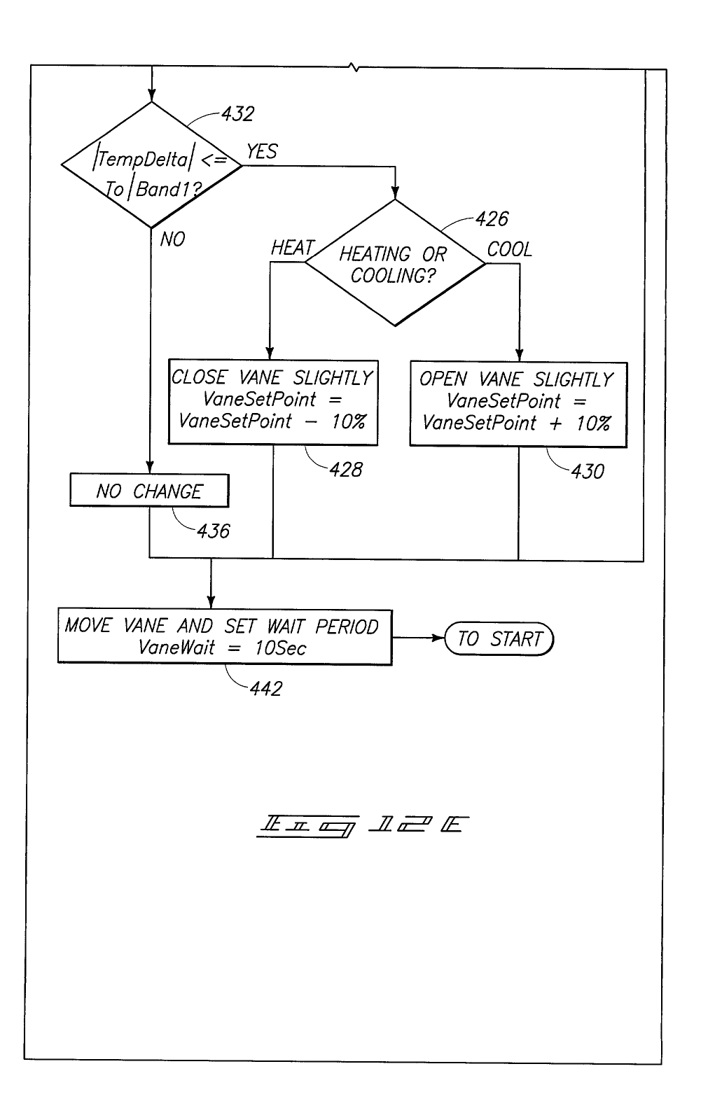

FIG. 11 is a map of how FIGS. 12A-E are to be assembled. FIGS. 12A-E, when assembled, provide a flow chart of logic employed in the control system 20, in one embodiments, instead of or in addition to the logic of FIGS. 8 and/or 9 and/or 10.

In block 400, the temperature of the hottest cartridge 14 is determined. After performing block 400, the controller proceeds to block 402.

In block 402, the control system determines whether the reading is reliable. If so, the control system proceeds to block 406. If not, the control system proceeds to block 404.

In block 404, an error is reported to the user; e.g., by way of a display or audible or visual signal, and the sensor reading is ignored. After performing block 404, the control system returns to block 402.

In block 406, the control system determines the output current at power bus 88. After performing block 406, the control system controls the vane of air passage 66 or controls the fan 60. The vane control and fan control can occur in parallel, or in sequence, or one or the other can be omitted.

In block 408, the control system calculates a temperature set point. In one embodiment, the temperature set point is calculated as follows, by way of example only:

| for | Cartridge Bus Amps: | (I) ≧ 172.0A |
|---|---|---|
| | Temperature Set Point | = 55.5° C. |
| for | Cartridge Bus Amps: | 50.0 A < (I) < 172.0A |
| | Temperature Set Point | = [7.63 × 10⁻⁴ (I)² − 6.16 × 10⁻² (I) + |
| | | 43.2] ° C. |
| for | Cartridge Bus Amps: | (I) ≦ 50.0A |
| | Temperature Set Point | = 37.0 00 |

After performing block 408, the control system proceeds to block 412.

In block 412, the control system calculates temperature delta. In one embodiment, temperature delta (or change in temperature) is calculated as follows:

Temperature Delta=Temperature Set Point−Hot Cartridge Temperature

where:

Hot Cartridge Temperature=Hottest Cartridge Heatsink Temperature

After performing block 412, the control system proceeds to block 414.

In block 414, a determination is made as to whether a suitable delay, initiated in block 442 below, has occurred. If so, the control system proceeds to block 416; if not, the control system proceeds to block 400.

In block 416, a determination is made as to whether the absolute value of the temperature delta determined in block 412 is greater than a second tolerance band value. If so, the control system proceeds to block 418; if not, the control system proceeds to block 420.

In block 418, the control system determines whether heating or cooling is desired. If heating, the control system proceeds to block 422; if cooling, the control system proceeds to block 424.

In block 422, the vane of air passage 66 is closed completely. After performing block 422, the control system proceeds to block 442.

In block 424, the control system opens the vane, of air passage 66, completely. After performing block 424, the control system proceeds to block 442.

In block 420, the control system determines whether the absolute value of the temperature delta determined in block 412 is less than or equal to a second tolerance band value and greater than a first tolerance band value. If so, the control system proceeds to block 426; if not, the control system proceeds to block 432.

In block 426, the control system determines whether heating or cooling is desired. If heating, the control system proceeds to block 428; if cooling the control system proceeds to block 430.

In block 428, the control system closes the vane, of air passage 66, partially. After performing block 428, the control system proceeds to block 442.

In block 430, the control system opens the vane partially. After performing block 430, the control system proceeds to block 442.

In block 432, the control system determines whether the absolute value of the temperature delta determined in block 412 is less than or equal to a first tolerance band value. If so, the control system proceeds to block 434; if not, the control system proceeds to block 436.

In block 434, the control system determines whether heating or cooling is desired. If heating, the control system proceeds to block 438; if cooling the control system proceeds to block 440.

In block 438, the control system closes the vane a slight amount. After performing block 438, the control system proceeds to block 442.

In block 440, the control system opens the vane a slight amount. After performing block 440, the control system proceeds to block 442.

In block 442, the control system moves the vane to the position selected in block 442, 424, 428, 430, 438, or 440 and sets a delay that is used in block 414. After performing block 442, the control system proceeds to block 400.

In block 410, a fan set point is determined. In one embodiment, the fan set point is determined as follows, for example:

for Cartridge Bus Amps: (I)<50.0 A

Fan Set Point=1500 RPM's

for Cartridge Bus Amps: (I)>50.0 A

Fan Set Point=[(I) (6.25)+1187] RPMs

After performing block 410, the control system proceeds to block 446.

In block 446, a determination is made as to whether a delay period set in block 458 has expired. If so, the control system proceeds to block 448; if not, the control system proceeds to block 400.

In block 448, the control system determines whether there is a cooling trend and whether the absolute value of temperature delta calculated in block 412 [or a similar block, not shown, between block 410 and block 446] is greater than a first tolerance band value. If it is desired to heat the cartridges 14, the control system proceeds to block 452. If it is desired to cool the cartridges 14, the control system proceeds to block 450.

In block 450, an increase in fan speed, for fan 60, is set. After performing block 450, the control system proceeds to block 454.

In block 452, a reduction in speed of the fan 60 is set. After performing block 452, the control system proceeds to block 454.

In block 454, the control system determines whether an increase in fan speed was set in block 450. If so, the control system proceeds to block 456; if not, the control system proceeds to block 458. In one embodiment, block 454 is omitted, and flow proceeds directly from block 450 to block 456, and from block 452 directly to block 458.

In block 456, a variable or signal representing fan speed is increased. For example, an increase in fan speed can be in 300 rpm increments, or other desired increments. After performing block 456, the control system proceeds to block 458.

In block 458, the fan speed is adjusted to the value of the variable of block 456, and a delay or a wait period is set. After performing block 458, the control system proceeds to block 400.

In a more general method, the current and/or temperature of the highest current and/or temperature cartridge or fuel cell is first measured. Then, a parameter is changed for all other cartridges or fuel cells, such as shunt duration, shunt frequency, bleed cycle, fan speed, vane position, or any other parameters that may affect performance. Then the temperatures and currents of the cartridges or fuel cells having changed parameters are measured. When they reach predetermined thresholds, such as the current and/or temperature of the highest current and/or temperature cartridge or fuel cell, the changed parameter may be returned to normal or moved back toward the normal direction. In one embodiment of this generalized method, a delay between power increase and temperature increase is taken into account to avoid an overshoot of maximum efficiency.

In one embodiment, there is a desired temperature and current for each fuel cell or cartridge, at which maximum efficiency operation occurs. Current is correlated to temperature, in one embodiment, based on an efficiency formula.

In one embodiment, the system 10 further includes an electronics bay 110 within or defined by the housing 12, which houses various electronic components, such as one or more of the control system 20, fuel sensor 64, current sensor 34, switching device 32, communication port 30, pressure sensor 104, and communication port 30, for example. In one embodiment, the system 10 further includes an electronics bay pressure sensor 104, in communication with the control system 20. If pressure exceeds a predetermined value, shut down circuitry 106 initiates a system shut down, in one embodiment. System shut down can comprise shutting off the supply of fuel, using valve 44, decoupling the fuel cells from a load, using switching device 32, for example, and generally ceasing operation. In one embodiment, the circuitry 106 is analog circuitry.

In one embodiment, the system 10 further includes one or more pressure sensors 108 in fluid communication with the fuel supply 42. For example, a pressure sensor can be provided for a main fuel supply line, or multiple pressure sensors can be provided, one for each cartridge, downstream of valves 46. In one embodiment, the shut down circuitry 106 initiates a system shut down if pressure sensed by the pressure sensor 108 is greater than a first predetermined value and/or less than a second predetermined value.

Thus, a fuel cell control system and method have been provided that allow for control of various fuel cell parameters in response to various conditions.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A fuel cell power system comprising:
a housing;
a fuel cell supported by the housing, configured to convert chemical energy into electrical energy to be selectively supplied to a load;
an air passage in the housing configured to move air relative to the fuel cell;
means for adjusting mass/energy flow through the air passage;
a sensor configured to sense a parameter of the fuel cell; and
a controller coupled to the current sensor to monitor current flow from the fuel cell to the load and to control mass/energy flow adjusting means in response to the sensed parameter.

2. A fuel cell power system in accordance with claim 1 wherein the sensor is a current sensor configured to sense current flowing through the fuel cell.

3. A fuel cell power system in accordance with claim 1 wherein the sensor is a temperature sensor configured to sense the temperature of the fuel cell.

4. A fuel cell power system in accordance with claim 3, wherein the mass/energy flow adjusting means comprises means for adjusting air flow through the air passage in response to the sensed temperature.

5. A fuel cell power system in accordance with claim 3, wherein the mass/energy flow adjusting means comprises a movable variable orifice movable between a first position at least partially blocking the air passage, and a second position in which less of the air passage is blocked by the vane than when the vane is in the first position and wherein the position of the vane is adjusted in response to sensed temperature.

6. A fuel cell power system in accordance with claim 1 wherein the mass/energy flow adjusting means comprises a movable vane movable between a first position at least partially blocking the air passage, and a second position in which less of the air passage is blocked by the vane than when the vane is in the first position.

7. A fuel cell power system in accordance with claim 1 wherein the mass/energy flow adjusting means comprises a variable speed fan, and controlling the mass/energy flow adjusting means comprises adjusting the speed of the fan.

8. A fuel cell power system comprising:
a housing;
a fuel cell supported by the housing, configured to convert chemical energy into electrical energy to be selectively supplied to a load;
a fan supported by the housing and configured to move air relative to the fuel cell;
a current sensor configured to determine current flow from the fuel cell to a load; and
a controller coupled to the current sensor to monitor current flow from the fuel cell to the load and to control the fan in response to the current flow.

9. The system of claim 8 wherein the fan is a variable speed fan.

10. The system of claim 9 wherein the controller is configured to control the speed of the fan in response to the current flow.

11. The system of claim 10 wherein the controller is configured to increase the speed of the fan, when current flow increases, and decrease the speed of the fan, when current flow decreases.

12. The system of claim 8 wherein the speed of the fan is adjustable between a maximum speed and off, and wherein controller is configured to increase the speed of the fan, when current flow increases, and decrease the speed of the fan, when current flow decreases, within limits defined by the maximum speed and off.

13. The system of claim 8 wherein the housing has an inside and outside, and an air passage between the inside and the outside, the system further comprising a variable orifice supported in the air passage for movement between first and second positions, and wherein the controller is configured to adjust the position of the vane in response to current flow to the load.

14. The system of claim 8 and comprising a plurality of fuel cells, wherein the fuel cells are configured to be individually selectively deactivated and remaining ones of the fuel cells are configured to provide electricity with others of the fuel cells deactivated.

15. The system of claim 8 and comprising a plurality of fuel cells, and a plurality of current sensors coupled to the controller and respectively arranged to sense current from at least one of the fuel cells.

16. The system of claim 8 and comprising a plurality of fuel cells, and a plurality of temperature sensors coupled to the controller and respectively arranged to sense temperature from at least one of the fuel cells.

17. The system of claim 14 and comprising cartridges respectively supporting groups of the fuel cells, and a current sensor coupled to each cartridge, to sense the current from the cartridge, the current sensors being coupled to the controller.

18. The system of claim 14 and comprising cartridges respectively supporting groups of the fuel cells, and temperature sensors supported by each cartridge, to sense the temperature of the cartridge, the temperature sensors being coupled to the controller.

19. A fuel cell power system comprising:
a housing having an interior and exterior, and an opening extending between the interior and exterior;
a fuel cell supported in the housing, configured to convert chemical energy into electrical energy to be selectively supplied to a load;
a variably openable air passage in fluid communication with the opening in the housing and configured to pass air relative to the fuel cell;
a current sensor configured to determine current flow from the fuel cell to a load; and
a controller coupled to the current sensor to monitor current flow from the fuel cell to the load and to control the air passage in response to the current flow.

20. The system of claim 19 wherein the air passage includes a vane that is selectively positionable in any of multiple possible positions between an open position and a closed position.

21. The system of claim 19 wherein the air passage is adjustable between open and closed positions and the controller is configured to adjust the air passage between the open and closed positions in response to the current flow.

22. The system of claim 21 wherein the controller is configured to adjust the air passage towards the open position in response to an increase in current flow, and to adjust the air passage towards the closed position in response to a decrease in current flow.

23. The system of claim 20 wherein the position of the vane is infinitely adjustable between the open position and the closed position, and wherein the controller is configured to open the vane, when current flow increases, and to close the vane, when current flow decreases, within limits defined by the open and closed positions.

24. The system of claim 19 and further comprising a fan supported by the housing and configured to adjustably move air in the air passage.

25. The system of claim 19 and comprising a plurality of fuel cells, wherein the fuel cells are configured to be individually selectively deactivated and remaining ones of the fuel cells are configured to provide electricity with others of the fuel cells deactivated.

26. The system of claim 19 and comprising a plurality of fuel cells, and a plurality of current sensors coupled to the controller and respectively arranged to sense current from at least one of the fuel cells.

27. The system of claim 19 and comprising a plurality of fuel cells, and a plurality of temperature sensors coupled to the controller and respectively arranged to sense temperature from at least one of the fuel cells.

28. The system of claim 25 and comprising cartridges respectively supporting groups of the fuel cells, and a current sensor coupled to each cartridge, to sense the current from the cartridge, the current sensors being coupled to the controller.

29. The system of claim 25 and comprising cartridges respectively supporting groups of the fuel cells, and temperature sensors supported by each cartridge, to sense the temperature of the cartridge, the temperature sensors being coupled to the controller.

30. A fuel cell power system comprising:
a fuel cell having a cathode and an anode adapted to be coupled to a fuel supply, and configured to produce electrical power having a current and voltage output;
a temperature sensor in temperature sensing relation to the fuel cell; and
a controller electrically coupled with the fuel cell and the temperature sensor, and configured to shunt current between the anode and cathode of the fuel cell according to a duty cycle, the controller further being configured to selectively adjust the duty cycle in response to the sensed temperature.

31. A fuel cell power system in accordance with claim 30 wherein the controller is configured to decrease frequency of shunting if temperature sensed by the temperature sensor exceeds a predetermined threshold.

32. A fuel cell power system in accordance with claim 30 wherein the controller is configured to decrease duration of shunting if temperature sensed by the temperature sensor exceeds a predetermined threshold.

33. A fuel cell power system in accordance with claim 30 wherein the controller is configured to increase frequency of shunting if temperature sensed by the temperature sensor is below a predetermined threshold.

34. A fuel cell power system in accordance with claim 30 wherein the controller is configured to increase duration of shunting if temperature sensed by the temperature sensor is below a predetermined threshold.

35. A fuel cell power system comprising:
a fuel cell having a cathode and an anode adapted to be coupled to a fuel supply, and configured to produce electrical power having a current and voltage output;
a current sensor configured to sense current produced by the fuel cell; and
a controller electrically coupled with the fuel cell and the current sensor, and configured to shunt current between the anode and cathode of the fuel cell according to a duty cycle, the controller further being configured to selectively adjust the duty cycle in response to the sensed current.

36. A fuel cell power system in accordance with claim 35 wherein the controller is configured to increase frequency of shunting if current sensed by the current sensor falls below a predetermined threshold.

37. A fuel cell power system in accordance with claim 35 wherein the controller is configured to increase duration of shunting if current sensed by the current sensor is below a predetermined threshold.

38. A fuel cell power system in accordance with claim 35 wherein the controller is configured to decrease duration of shunting if current sensed by the current sensor is above a predetermined threshold.

39. A fuel cell power method comprising:
providing a housing;
supporting a fuel cell from the housing, and converting chemical energy into electrical energy to be selectively supplied to a load;
providing an air passage in the housing to move air relative to the fuel cell;
adjusting mass/energy flow through the air passage;
determining a parameter of the fuel cell; and
controlling mass/energy flow in response to the parameter.

40. A fuel cell power method in accordance with claim 39 wherein the parameter is current.

41. A fuel cell power method in accordance with claim 39 wherein the parameter is temperature.

42. A fuel cell power method in accordance with claim 41 wherein controlling the mass/energy flow comprises adjusting air flow through the air passage in response to the sensed temperature.

43. A fuel cell power method in accordance with claim 41 wherein adjusting mass/energy flow comprises providing a movable vane movable between a first position at least partially blocking the air passage, and a second position in which less of the air passage is blocked by the vane than when the vane is in the first position, and further comprising positioning the vane in response to the sensed temperature.

44. A fuel cell power method in accordance with claim 39 wherein adjusting mass/energy flow comprises providing a movable vane movable between a first position at least partially blocking the air passage, and a second position in which less of the air passage is blocked by the vane than when the vane is in the first position.

45. A fuel cell power method in accordance with claim 39 wherein adjusting the mass/energy flow comprises adjusting the speed of a variable speed fan.

46. A fuel cell power method in accordance with claim 39 wherein adjusting mass/energy flow comprises adjusting air flow through th e air passage.

47. A fuel cell power method in accordance with claim 39 and further comprising providing a variable speed fan supported by the housing to move air through the air passage, and wherein adjusting mass/energy flow comprises adjusting the speed of the fan.

48. A fuel cell power method comprising:
providing a housing;
supporting a fuel cell by the housing, and converting chemical energy into electrical energy to be selectively supplied to a load, using the fuel cell;
moving air relative to the fuel cell using a fan supported by the housing;
determining current flow from the fuel cell to a load, using a current sensor; and
monitoring current flow from the fuel cell to the load and controlling the fan in response to the current flow.

49. The method of claim 48 wherein the fan is a variable speed fan.

50. The method of claim 49 and further comprising controlling the speed of the fan in response to the current flow.

51. The method of claim 50 and further comprising increasing the speed of the fan, when current flow increases, and decreasing the speed of the fan, when current flow decreases.

52. The method of claim 48 wherein the speed of the fan is adjustable between a maximum speed and off, and the method comprises increasing the speed of the fan, when current flow increases, and decreasing the speed of the fan, when current flow decreases, within limits defined by the maximum speed and off.

53. The method of claim 48 wherein the housing has an inside and outside, and an air passage between the inside and the outside, the method further comprising providing a vane in the air passage for movement between first and second positions, and adjusting the position of the vane in response to current flow to the load.

54. The method of claim 48 and comprising providing a plurality of fuel cells, and configuring the fuel cells to be individually selectively deactivated with remaining ones of the fuel cells continuing to provide electricity.

55. The method of claim 48 and comprising providing a plurality of fuel cells, and sensing current from at least one of the fuel cells.

56. The method of claim 48 and comprising providing a plurality of fuel cells, and sensing temperature from at least one of the fuel cells.

57. The method of claim 54 and comprising supporting groups of the fuel cells in cartridges, and sensing the current from cartridges.

58. The method of claim 54 and comprising supporting groups of the fuel cells in cartridges, and sensing the temperature of each cartridge.

59. A fuel cell power method comprising:
providing a housing having an interior and exterior, and an opening extending between the interior and exterior;
supporting a fuel cell supported in the housing, and converting chemical energy into electrical energy to be selectively supplied to a load, using the fuel cell;
passing air relative to the fuel cell from a variably openable air passage in fluid communication with the opening in the housing;
determining current flow from the fuel cell to a load using a current sensor; and
monitoring current flow from the fuel cell to the load, and controlling the air passage in response to the current flow.

60. The method of claim 59 wherein the air passage includes a vane that is selectively positionable in any of multiple possible positions between an open position and a closed position.

61. The method of claim 59 wherein the air passage is adjustable between open and closed positions, and further comprising adjusting the air passage between the open and closed positions in response to the current flow.

62. The method of claim 61 and further comprising adjusting the air passage towards the open position in response to an increase in current flow, and adjusting the air passage towards the closed position in response to a decrease in current flow.

63. The method of claim 60 wherein the position of the vane is continuously adjustable between the open position and the closed position, the method further comprising opening the vane, when current flow increases, and closing the vane, when current flow decreases, within limits defined by the open and closed positions.

64. The method of claim 59 and further comprising supporting a fan supported by the housing to adjustably move air in the air passage.

65. The method of claim 59 and further comprising providing a plurality of fuel cells, and configuring the fuel cells to be individually selectively deactivated with remaining ones of the fuel cells continuing to provide electricity.

66. The method of claim 59 and comprising providing a plurality of fuel cells, and sensing current from at least one of the fuel cells.

67. The method of claim 59 and comprising providing a plurality of fuel cells, and sensing temperature from at least one of the fuel cells.

68. The method of claim 65 and comprising supporting groups of the fuel cells in cartridges, and sensing current of each cartridge.

69. The method of claim 65 and comprising supporting groups of the fuel cells in cartridges, and sensing the temperature of each cartridge.

70. A fuel cell method comprising:
providing a fuel cell having a cathode and an anode adapted to be coupled to a fuel supply, and configured to produce electrical power having a current and voltage output;
providing a temperature sensor in temperature sensing relation to the fuel cell; and
shunting current between the anode and cathode of the fuel cell according to a duty cycle, and selectively adjusting the duty cycle in response to the sensed temperature.

71. A fuel cell power method in accordance with claim 70 wherein the frequency of shunting is decreased if temperature sensed by the temperature sensor exceeds a predetermined threshold.

72. A fuel cell power method in accordance with claim 70 wherein the duration of shunting is decreased if temperature sensed by the temperature sensor exceeds a predetermined threshold.

73. A fuel cell power method in accordance with claim 70 wherein frequency of shunting is increased if temperature sensed by the temperature sensor is below a predetermined threshold.

74. A fuel cell power method in accordance with claim 70 wherein the duration of shunting is increased if temperature sensed by the temperature sensor is below a predetermined threshold.

75. A fuel cell power method comprising:
providing a fuel cell having a cathode and an anode adapted to be coupled to a fuel supply, and configured to produce electrical power having a current and voltage output;
providing a current sensor configured to sense current produced by the fuel cell; and
shunting current between the anode and cathode of the fuel cell according to a duty cycle, and selectively adjusting the duty cycle in response to the sensed current.

76. A fuel cell power method in accordance with claim 75 wherein the frequency of shunting is increased if current sensed by the current sensor falls below a predetermined threshold.

77. A fuel cell power method in accordance with claim 75 wherein the duration of shunting is increased if current sensed by the current sensor is below a predetermined threshold.

78. A fuel cell power method in accordance with claim 75 wherein the duration of shunting is decreased if current sensed by the current sensor is above a predetermined threshold.
